(19) United States
(12) Patent Application Publication
(10) Pub. No.: US 2017/0321598 A1
(43) Pub. Date: Nov. 9, 2017

(54) ENERGY SYSTEM OR APPARATUS AND METHOD OF ENERGY SYSTEM OR APPARATUS OPERATION OR CONTROL

(71) Applicant: Donald Williams, The Woodlands, TX (US)

(72) Inventor: Donald Williams, The Woodlands, TX (US)

(21) Appl. No.: 15/587,308

(22) Filed: May 4, 2017

Related U.S. Application Data
(60) Provisional application No. 62/331,922, filed on May 4, 2016.

(51) Int. Cl. F02B 19/10; F02M 31/093; F02M 7/04; F02D 41/38; F02M 7/10; F02D 41/30; H01M 8/0612

(52) U.S. Cl. CPC F02B 19/1052; F02M 7/10; F02M 31/093; F02D 41/3082; F02M 7/04; F02D 41/3836; H01M 8/0631

(57) ABSTRACT

Presented herein is an energy conversion module containing an internal combustion engine, air compressor, fuel delivery system, waste energy collection system and emission control system. Energy input is controlled via a feedback loop containing an air compressor, carburetor and post-combustion oxygen sensor. Emissions are controlled via the use of a high-efficiency catalytic converter and exhaust gas recirculation system via a feedback from post-catalytic oxygen sensors. Waste heat energy is also collected from both the combustion and catalytic processes via a series of heat exchangers and a high-heat capacity medium.

### CROSS-REFERENCE TO RELATED APPLICATIONS

The present application claims the benefit of U.S. Provisional Patent Application No. 62/331,922, filed on May 4, 2016 (pending), the entirety of which is incorporated herein by reference for all purposes and made a part of the present disclosure.

### FIELD

The present disclosure relates to, among other things, an energy handling, generating, or converting system, components therefor, and a method of operating or controlling same, or method of energy handling or generation.

### BACKGROUND

The combined effects of increased energy demand, diminishing fuel supplies and their potential damaging effects support the need for energy management technologies. Total world primary energy consumption has doubled from roughly 71 TWh to 155 TWh per year in the last 35 years. Although much research has been focused on the development of clean and renewable energy sources, advances to make such technologies sufficiently feasible as to practically impact this demand as a viable resource remain elusive, with fossil fuels still accounting for nearly 75% of all primary energy used. However, such fuel is naturally limited, with current predictions estimating 100-200 years for natural gas and 1000-3000 years for coal and oil based on current consumption and mining technologies. Further, the use of such fuel has detrimental side effects, from global warming to toxic emissions resulting from the combustion process. Give human dependence on such fossil fuels for the relatively foreseeable future, coupled with the vast and rapid industrialization of developing populations with an ever increasing use of energy consuming technologies and applications, a safe, economical and highly efficient generic fossil fuel conversion system could positively impact energy management.

Conventional fossil fuel systems are employed in a wide range of applications from electrical power stations and automobile engines to HVAC systems and portable generators. However, each is designed to accommodate a particular task optimized to custom design constraints, and are thus not generally adaptable, safe, economical or efficient for other tasks. Power plants and generators, for example, though capable of producing energy in the very pliable form of electricity do so at the cost of generating waste heat, which is disposed of because the technology to package and distribute such waste heat energy is not feasible. Loss of energy as waste heat in such systems lowers the overall consumable energy efficiency of the systems to 40-50%. Further, heat generating furnaces and water heaters, though highly efficient, cannot be used to generate any other form of usable energy, thus limiting their applications. Though it has been conventional practice to naturally design energy systems according to a given application, such lack of continuity and adaptability negatively impacts overall efficiency, including fuel consumption efficiency, waste generation efficiency, and energy production efficiency, as well as installation and management costs, particularly in light of the world's high flux, highly dynamic energy profiles.

### SUMMARY

The present disclosure relates to, among other things, an energy handling, generating, or converting system, components therefor, and a method of operating or controlling the same. The present disclosure also relates to a method of controlling an energy handling system or an internal combustion engine, such as a fossil fuel supplied (liquid or gas) internal combustion engine having a carburetor.

In one aspect, the present disclosure seeks to improve upon conventional design by providing an economical, highly efficient, low emissive, and/or readily adaptable generic fossil fuel conversion or energy handling system. Principle design elements of embodiments of the systems and methods disclosed herein may include, but are not limited to: high energy density, high energy efficiency, high reliability, low emissions, easy adaptability, and low cost.

Having a high energy density increases the number of potential applications by affording a smaller size and facilitating transport. High energy density may be achieved, at least in part, by incorporating an electrical air compressor into the air intake of an internal combustion engine to provide more oxygen than ambient air pressure aspirating systems for a given engine displacement.

In one aspect, high energy efficiency is achieved by minimizing parasitic losses of energy, thus utilizing as much stored fuel energy as possible by exporting both mechanical energy from the crankshaft of the internal combustion engine and heat energy via a waste het recovery system (e.g., series of heat exchangers). A generator and/or mechanically or electrically driven compressor may be operatively coupled to the internal combustion engine to provide electrical energy and a source of vapor compression cooling.

High reliability and low cost of the systems disclosed herein may be achieved by standardizing parts and materials used in the system, as well as retaining a minimalist design structure and relying on simple construction and control of the system.

In some embodiments, low emissions may be achieved in the system using a feedback system that incorporates a controlled forced induction system (e.g., air compressor), a high efficiency catalytic converter, and an external exhaust gas recirculation system.

Embodiments of the system may also be designed to be relatively easy to adapt to a wide variety of applications, fuel types, installation topologies and energy supply requirements. For example, adaptors and varying control parameters may be utilized to afford the use of either gas or liquid fuels as well as to provide mechanical, electrical and/or heating and cooling energy solutions. Also, increased efficiency may be achieved by use of waste heat management, which lowers exhaust temperatures, allowing for system installation in temperature sensitive environments.

In one aspect, the present disclosure relates to an energy conversion or transfer system. The energy conversion or transfer system includes an internal combustion engine. A fuel-air delivery system is in fluid communication with the internal combustion engine. The fuel-air delivery system includes an air intake and a carburetor. The air intake is equipped with an air compressor. The carburetor is disposed to receive compressed intake air from the air compressor and fuel from a fuel supply. The internal combustion engine is disposed to receive an air/fuel mixture from the carburetor. The air/fuel mixture includes the fuel mixed with the compressed intake air.

In another aspect, the present disclosure relates to a method of controlling an energy conversion or transfer system. The method includes providing an internal combustion engine having a fuel-air delivery system that includes an air intake and a carburetor. The method includes equipping the air intake with an air compressor. The method includes operating the internal combustion engine, including delivering an air/fuel mixture from the carburetor to the internal combustion engine. The method also includes adjusting the air/fuel ratio by controlling air intake into the internal combustion engine and fuel supply into the carburetor. The air intake is controlled by regulating the air compressor speed.

### BRIEF DESCRIPTION OF DRAWINGS

So that the manner in which the features and advantages of embodiments of the present disclosure may be understood in more detail, a more particular description of the briefly summarized embodiments above may be had by reference to the embodiments which are illustrated in the appended drawings that form a part of this specification. It is to be noted, however, that the drawings illustrate only various exemplary embodiments, and are therefore not to be considered limiting of the scope of this disclosure, as it may include other effective embodiments as well.

FIG. 1A is a schematic of an energy handling system or apparatus according to the present disclosure;

FIG. 1B is a perspective view of an exemplary energy handling system or apparatus according to the present disclosure;

FIG. 2 is a simplified process diagram for operating or controlling an energy handling system or apparatus according to the present disclosure;

FIGS. 3A-3D are schematics of exemplary energy handling system or apparatus in accordance with the present disclosure; and

FIG. 4 is a schematic of an energy handling system or apparatus in accordance with the present disclosure.

### DETAILED DESCRIPTION

Examples of the present disclosure will now be described more fully with reference to the accompanying drawings, which illustrate various exemplary systems, apparatus, and methods. The disclosed concepts may, however, be embodied in many different forms and should not be construed as being limited by the illustrated examples set forth herein. Rather, the examples illustrated herein are provided so that this disclosure will be thorough as well as complete and will fully convey the scope to those skilled in the art and modes of practicing the embodiments.

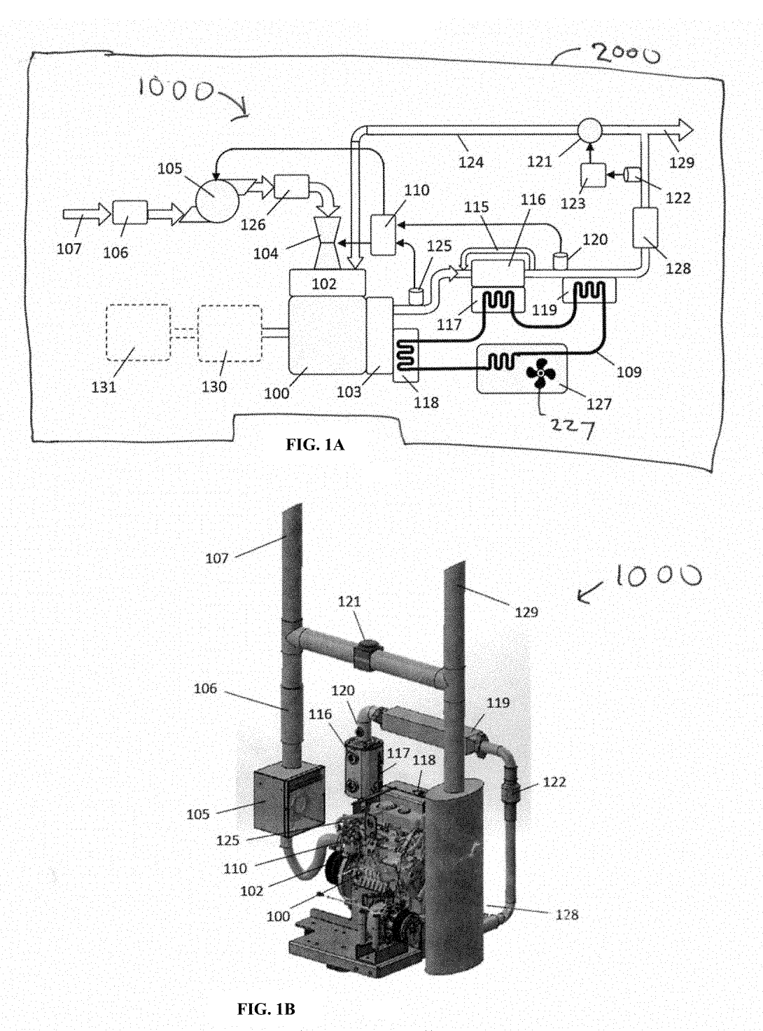

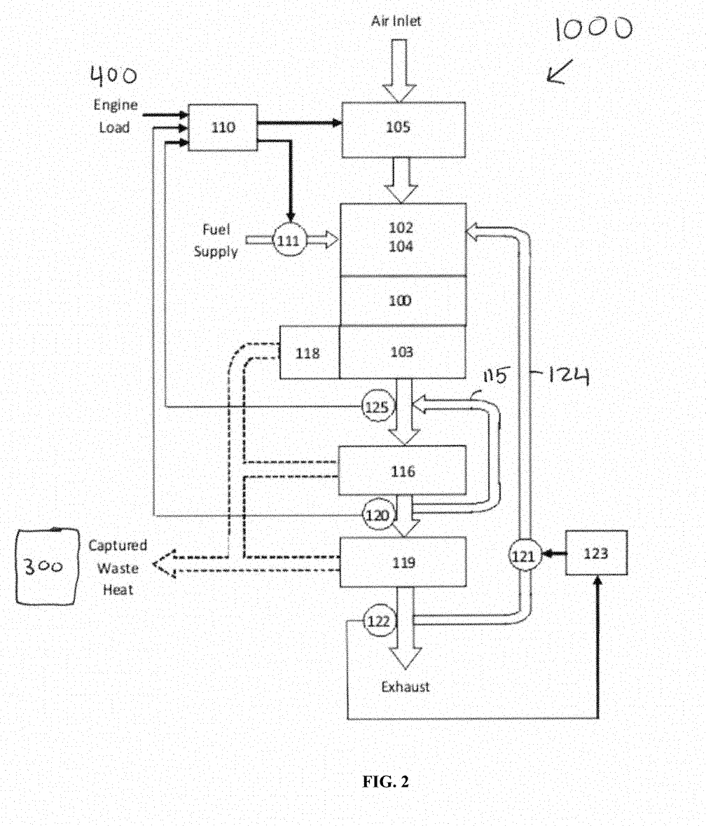

In one aspect, the present disclosure relate to an energy conversion or transfer system. With reference to FIGS. 1A, 1B, and 2, the energy conversion or transfer system, system 1000, includes internal combustion engine (ICE), which is composed of engine block 100, intake manifold 102, and exhaust manifold 103. In some applications, system 1000 is installed at or within a facility 2000. Facility 2000 may be, for example and without limitation, a residential facility (e.g., house) or a commercial facility (e.g., a factory or warehouse).

System 1000 includes a fuel-air delivery system in fluid communication with the internal combustion engine. Fuel-air delivery system includes air intake 107 and carburetor 104. Air intake 107 may be equipped with air compressor 105.

### Carburetor

Carburetor 104 is disposed to receive compressed intake air from air compressor 105 and fuel from fuel supply 111, for forming an air/fuel mixture that includes the fuel mixed with the compressed intake air. In certain embodiments, carburetor 104 is a venture-type carburetor. Use of a venture-type carburetor may provide lower cost, increased design simplicity, and easier manufacture and maintenance in comparison to electronic fuel injection (EFI). Additionally, use of a venture-type carburetor may facilitate the use of system 1000 with both liquid and gas fuel sources, requiring minimal alterations compared to the relatively more complex modifications required by EFI systems to accommodate multiple fuel types. As such, use of a venture-type carburetor may provide system 1000 with a more universal, adaptive design.

Internal combustion engine is disposed to receive the air/fuel mixture from carburetor 104. As shown, intake manifold 102 is in fluid communication between engine block 100 and carburetor 104.

### Forced Induction System

In certain embodiments, intake air passes through air filter 106 upstream of air compressor 105 to remove dirt and particulates contained within intake air. After passing through air filter 106, intake air flows into a forced induction system of the air intake. The forced induction system is composed of air compressor 105, which is in fluid communication with an air inlet of carburetor 104. In some embodiments, air compressor 105 is attached to or otherwise mechanically coupled to the air inlet of carburetor 104. Air compressor 105 operates to increase the energy density of system 1000, while also enhancing volumetric and thermal efficiencies of the combustion process, resulting in a more complete burn of fuel and reduced emissions from system 1000. In certain embodiments, air compressor 105 is an electrically air compressor (i.e., electrically driven), which may provide advantages in comparison to other types of air compressors, such as mechanical or exhaust driven air compressors. For example, while exhaust or turbo driven air compressors may be more energy efficient than at least some electrical air compressors due to the use of waste heat energy, dependence upon exhaust pressures as a driver source of such compressors limits the available dynamic range thereof. Such exhaust or turbo driven air compressors may exhibit lags or delays in boost delivery, as well as insufficient compression during low RPM, high torque conditions of the ICE when air compression is required. Excluding the use of such exhaust or turbo driven air compressors in system 1000 allows system 1000 to accommodate a wide range of load scenarios. Furthermore, mechanical air compressors may be linked to a crankshaft of ICE. Due to such crankshaft linkage, and hence dependence on the RPM of the ICE for drive command, embodiments of mechanical air compressors may lack sufficient adaptability (e.g., overpowering the system during light loads) to adequately accommodate a wide range of applications. Electrically driven air compressor 105 is free of direct ICE dynamics, and allows for independent control of air compressor 105 at any and all levels of ICE torque and RPM. Such features of electrically driven air compressor 105, in combination with the ease of installation of electrically driven air compressor 105, make electrically driven air compressor 105 highly adaptable and performance compliant over a wide and dynamic range of ICE operation. In some embodiments, air intake 107 is not equipped with a turbocharger and/or a supercharger. In some embodiments, air compressor 105 is not mechanically or exhaust driven. In certain embodiments, air compressor 105 is controlled independent of control and operation of ICE, i.e., in some embodiments control of air compressor 105 is not dependent upon control or operation of ICE.

System 1000 includes post-compressor heat exchanger or intercooler 126 in fluid communication between air compressor 105 and carburetor 104. At least some excess heat added to the intake air by the adiabatic compression of air compressor 105 may be recovered by post-compressor heat exchanger or intercooler 126. Use of post compressor heat exchanger or intercooler 126 may further increase air density, compression ratios, and lower temperatures of intake air, providing a more thorough and complete combustion of fuel in ICE. While system 1000 is shown as including post-compressor heat exchanger or intercooler 126, some embodiments of the system do not include a post-compressor heat exchanger or intercooler 126 is not required.

### Catalytic Converter

Upon exiting the combustion chamber within engine block 100, exhaust gases pass through exhaust manifold 103, and through an emission reduction system composed of catalytic converter 116, catalytic converter recycle 115, EGR valve 121, return line 124, and oxygen sensors 120,122.

Catalytic converter 116 disposed downstream of the internal combustion engine. Catalytic converter 116 is disposed to receive exhaust from the internal combustion engine. In some embodiments, catalytic converter 116 is a high-efficiency, 3-way catalytic converter as disclosed in U.S. Pat. No. 7,807,120 (the '120 Patent), the entirety of which is incorporated herein by reference. Catalytic converter 116 is downstream of and in fluid communication with exhaust manifold 103 of ICE. Exhaust manifold 103 is disposed to receive and expel exhaust of engine block 100. As described in more detail in the incorporated '120 Patent, 3-way catalytic converter 116 enhances efficiency by recirculating post catalytic gas back through the reaction chamber of catalytic converter 116 via catalytic converter recycle 115. Also, as described the '120 Patent, 3-way catalytic converter 116 includes a heat exchanger that jackets the reaction chamber surface of catalytic converter 116. In addition to providing an additional chance at reaction for unconverted elements, recirculation of catalytic gas heated by exothermic redox reactions spreads through the heat exchanger jacket, increasing the temperature and effective surface area of the reaction chamber, thus enhancing conversion efficiency of catalytic converter 116.

Upon exiting catalytic converter 116, exhaust gas is then passed through muffler 128 before exiting to the atmosphere via tailpipe 129. When exhaust gas recirculation (EGR) valve 121 is at least partially opened, at least a portion of exhaust gas flows back into the combustion chamber of engine block 100 via return line 124 and intake manifold 102.

### Feed Back Control Subsystem

System 1000 includes feed back control subsystem 110, which includes or is in data communication with at least one gas sensor (e.g., 125 and 120). Feed back control subsystem 110 is further in data communication with air compressor 105 and fuel supply 111 of carburetor 104.

Gas sensors of feed back control subsystem 110 may be sensors configured to detect any type of gas within exhaust gas, such as O₂, CO, CO₂, NOₓ, or combinations thereof. In one embodiment, gas sensors of feed back control subsystem 110 are oxygen sensors (e.g., lambda sensors). Feed back control subsystem 110 includes at least one oxygen sensor positioned downstream of the internal combustion engine, including post-combustion oxygen sensor 125 positioned downstream of the internal combustion engine and upstream of catalytic converter 116, and post-catalytic oxygen sensor 120 positioned downstream of both the internal combustion engine and catalytic converter 116. While system 1000 is described as including oxygen sensors 120 and 125 in the positions as shown, system 1000 is not limited to this particular embodiment, and may include more or less oxygen sensors positioned at different points along exhaust from ICE.

In operation, oxygen sensor 125 detects the presence and content levels of oxygen within exhaust gas downstream of engine block 100 and upstream of catalytic converter 116, and oxygen sensor 120 detects the presence and content levels of oxygen within exhaust gas downstream of both engine block 100 and catalytic converter 116. Data signals representative of the presence and content levels of oxygen within exhaust gas are transmitted from oxygen sensors 125 and 120 to feed back control subsystem 110. Feed back control subsystem 110 then processes the data signals (e.g., using algorithms) to determine operational parameters of air compressor 105, fuel supply 111, carburetor 104, or combinations thereof. Feed back control subsystem 110 then transmits control signals to air compressor 105, fuel supply 111, carburetor 104, or combinations thereof based upon the determined operational parameters. For example and without limitation, the operational parameters of air compressor 105 that may be controlled based upon oxygen content levels within exhaust gas include air compressor speed. The operational parameters of fuel supply 111 that may be controlled based upon oxygen content levels within exhaust gas include, but are not limited to, flow rate of fuel from fuel supply 111 into engine block. For example, feed back control subsystem 110 may open, close, or throttle a valve between fuel supply 111 and carburetor 104. As such, feed back control subsystem 110 is configured to adjust the air/fuel ratio within the combustion chamber of engine block 100 by controlling air intake into the internal combustion engine, fuel supply 111 into carburetor 104, or combinations thereof. Feed back control subsystem 110 may control air intake into the internal combustion engine by regulating air compressor speed of air compressor 105, regulating flow rate from fuel supply 111, or combinations thereof. Adjustment of the air/fuel ratio may be performed to maximize stoichiometric combustion efficiency within the internal combustion engine. Thus, in addition to increasing energy density, the forced air induction system disclosed herein may also be used to implement an oxygen dosing control system composed of air compressor 105, carburetor 104, fuel supply 111, feed back control subsystem 110, and oxygen sensors 125, 120, which serves to increase combustion efficiencies and minimize toxic emissions of ICE. Feed back control subsystem 110 may be a proportional integral derivative (PID) controller configured to operatively control fuel supply 111, air compressor 105, carburetor 104, or combinations thereof.

Without being bound by theory, while stoichiometric combustion provides maximum efficiency, it is difficult, if not impossible, to achieve in practice due to non-ideal combustion and air/fuel mixing processes. The insufficient air of rich air/fuel mixtures results in incomplete oxidation and unburned hydrocarbons (HC) and CO, thus reducing combustion efficiencies and generating emissions. The excess air of lean air/fuel mixtures reduces volumetric and thermal efficiencies due to the presence of excess oxygen and nitrogen. Furthermore, pre-detonation, component stress, and emission control are also affected by the air/fuel delivery. Adjustment of the air/fuel mixture allows for optimization of ICE performance over varying engine loads.

Without being bound by theory, the dynamics of naturally aspirated, carbureted fuel systems are limited by engine displacement and carburetor architecture, as indicative of the lowered fuel efficiencies of automobile engines at idle and full throttle conditions. However, electric drive air compressor 105 is free to vary the air supply to carburetor 104 independent of the engine size or engine load status. Feed back control subsystem 110 may control air compressor 105 within a PID control loop to force engine operation to near stoichiometric performance over the entire dynamic range of the ICE. Feed back control subsystem 110 may also control fuel supply 111 within a PID control loop to force engine operation to near stoichiometric performance over the entire dynamic range of the ICE. In some embodiments, feed back control subsystem 110 may be fully programmable and adjusted to accommodate various control scenarios, various fuels, and various applications. For example, feed back control subsystem 110 may be programmed to bias the feedback control for a slight excess air component to insure a clean and complete burn of fuel, sacrificing power for lower emissions.

In certain embodiments, post-catalytic oxygen sensor 120 is used in feed back control subsystem 110 to provide real-time adaptive control of the air/fuel mixture to control post-combustion oxygen content, thereby maximizing both the catalyst oxidation of carbon monoxide (CO) and hydrocarbons (HC), as well as reducing nitrous oxides (NOx) present in exhaust gas under a wide range of engine operating conditions. Feedback of post-catalytic oxygen measurements may be used to maintain optimal catalytic operation of catalytic converter 116.

### Exhaust Gas Recirculating System

System 1000 includes an exhaust gas recirculating system in fluid communication with catalytic converter 116. The exhaust gas recirculating system is disposed to recirculate at least a portion of exhaust gas from catalytic converter 116 to the internal combustion engine via return line 124. The exhaust gas recirculating system is composed of oxygen sensor 122, controller 123 (e.g., actuator) in data communication with oxygen sensor 122, and exhaust gas recovery (EGR) valve 121 in data and/or operative communication with controller 123. Oxygen sensor 122 is disposed to detect an oxygen content of the exhaust gas downstream of catalytic converter 116 and muffler 128. Oxygen sensor 122 detects oxygen content levels within the exhaust gas, forms a data signal representative of the oxygen content levels within the exhaust gas, and transmits that data signal to controller 123. Controller 123 is configured to be responsive to the data signals from oxygen sensor 122 to control operation of EGR valve 121. EGR valve 121 is disposed to recycle exhaust gas to the internal combustion engine based on excess oxygen content in the exhaust as measured by oxygen sensor 122. In some embodiments, controller 123 is a solenoid circuit configured to fully open and fully close EGR valve 121 based on a trip point of oxygen content in the exhaust gas. In other embodiments, controller 123 is PID controller configured to throttle EGR valve 121 over a range of oxygen content values in the exhaust. Exhaust gas recirculating system may be used to fine tune emissions content for system 1000. The external exhaust gas recirculation feedback control further reduces emissions by recirculating a portion of the exhaust gas back to intake manifold 102 via return line 124. As such, unburned hydrocarbons in exhaust gas have an additional opportunity to be oxidized and displace oxygen with inert particulates, thus absorbing combustion heat and further decreasing peak cylinder temperatures to reduce NO_{R} in the exhaust gas. In some embodiments, EGR valve 121 is not indirectly controlled based upon sensing of manifold (e.g., 102) pressures and exhaust temperatures, or is not only controlled based upon sensing of manifold (e.g., 102) pressures and exhaust temperatures. The external exhaust gas recirculation feedback control allows control of emissions by directly measuring exhaust gas chemical content (e.g., oxygen content). While exhaust gas recirculating system is described as including oxygen sensor 122, the exhaust gas recirculating system is not limited to oxygen sensors, and may include other gas sensors, such as sensors that measure the content levels of CO, CO₂ and NOₓ. The particular sensors used in the exhaust gas recirculating system may be varied depending upon system complexity and the desired control scenario.

### Waste Heat Energy System

In some embodiments, system 1000 includes a waste heat energy system disposed to collect heat from the internal combustion engine and from catalytic converter 116. The waste heat energy system in FIGS. 1A, 1B, and 2 includes heat exchanger 118 positioned in heat transfer relation to exhaust emitted from internal combustion engine, heat exchanger 117 positioned in heat transfer relation to catalytic converter 116, and heat exchanger 119 positioned in heat transfer relation to exhaust downstream of catalytic converter 116. However, the waste heat energy system is not limited to this particular number or arrangement of heat exchangers, and may include any number or arrangement of heat exchangers downstream of combustion within engine block 100. The waste heat energy system includes at least one dump or export heat exchanger 127 in heat transfer relation with each heat exchanger 117, 118, 119 of the waste heat energy system. Heat exchanger 127 may include fan 227 for exhausting heat therefrom.

In some embodiments, as shown in FIG. 2, the waste heat energy system exports heat from the internal combustion engine and catalytic convertor 116 to external heat sink 300. External heat sink 300 may be, for example and without limitation, a heating ventilation system, a boiler, a heater for water distillation, or combinations thereof.

The heat exchangers of the waste heat energy system may include a series of pick-up heat exchangers (e.g., heat exchanges 117, 118 and 119) located adjacent to primary areas of waste heat production, such as exhaust manifold 103, catalytic converter 116, and exhaust pipes downstream of catalytic converter 116. The heat exchangers of the waste heat energy system may be constructed in typical geometries exhibiting large surface areas and thermally conductive materials to provide maximum heat transfer to a recovery medium within conduit 109. The recovery medium may be a high-heat capacity liquid that circulates through heat exchangers 117, 118, 119 within the conduit 109 for transfer via heat exchanger 127 for use with external heat sinks 300. As such, the efficiency of system 1000 is increased by making fuel energy that would otherwise be wasted (e.g., as exhaust heat) available for use in tasks such as heating and ventilation, heating and boiling water, distillation of liquid waste for drinking, and/or heating of biomass for the generation of synthetic fuels.

### Electric Generator and Compressor

System 1000 includes electric generator 130 and compressor 131. While system 1000 is shown including both electric generator 130 and compressor 131, other embodiments may include only one of electric generator 130 or compressor 131. Electric generator 130 and compressor 131 are operatively coupled to the internal combustion engine. For example and without limitation, the crankshaft of the ICE may be attached to electric generator 130 and/or compressor 131 to allow fuel energy from combustion to be converted into electrical energy for use in powering lights, industrial equipment, appliances, charging batteries, and other electrical devices and systems, as well as to provide compression for use in vapor compression refrigeration systems such as air conditioners, freezers, and dehumidifiers. Compressor 131 may be driven mechanically from the crankshaft or electrically via electric generator 130, further increasing the adaptability and universal applicability of system 1000.

### System Operation

FIG. 2 is a block diagram of system 1000. As shown, engine load 400 may communicated to feed back control subsystem 110. Engine load 400 may be determined in various ways, depending upon the specific configuration of system 1000. For example, mechanical engine load may be determined using intake air flow, manifold pressures, temperatures, throttle position, and RPM per conventional control algorithms, such as those defined by SAE International SAE J1979/ISO 15031-5 standards. As would be understood by one skilled in the art, in embodiments in which the engine is used as an electric generator, engine load may be determined based upon the load current and voltage when mechanical factors are tuned and corresponding variables are characterized. As shown in FIG. 2, oxygen sensors 125 and 120 provide feedback data for controlling air compressor 105 and fuel supply 111 (e.g., fuel pump) so as to maximize combustion stoichiometry and catalytic performance, respectively. While, oxygen sensor 122 is used with controller 123 and EGR valve 121 to recycle exhaust gas based on excess oxygen content.

For system 1000 to be highly efficient and adaptable to varying applications and energy solutions, system 1000 may be designed to capture and utilize as much of the fuel energy as possible, which in-turn may be made available in a number of forms. As depicted, system 1000 transforms chemical energy into mechanical and thermal energy within the combustion changer engine block 100. At least some of the mechanical energy formed within the combustion changer engine block 100 is then transformed into electrical energy via electric generator 130, or may be used for compression via compressor 131. At least some of the thermal energy formed within the combustion changer engine block 100 is transferred to the waste heat energy system via heat exchangers 117, 118, 119, and 127.

### Alternative Embodiments of System

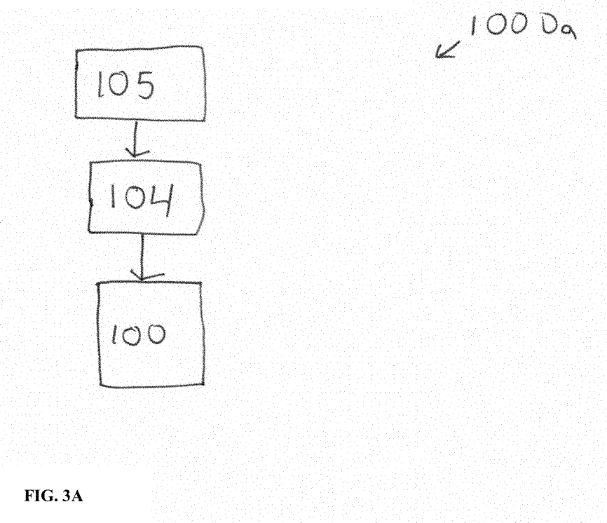

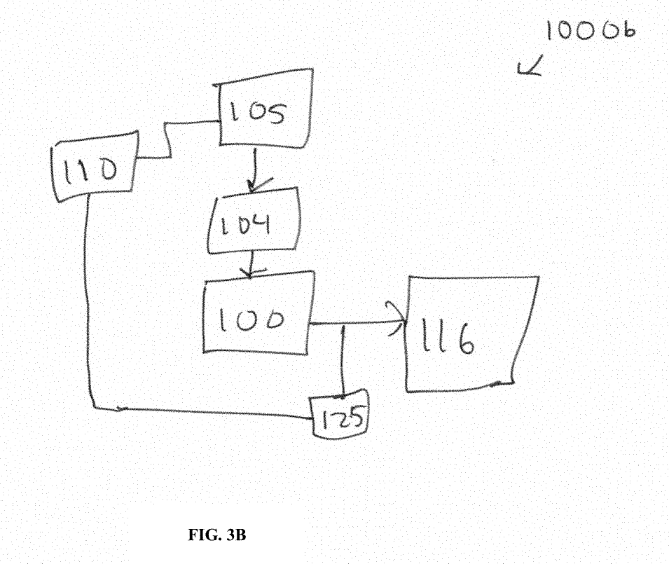

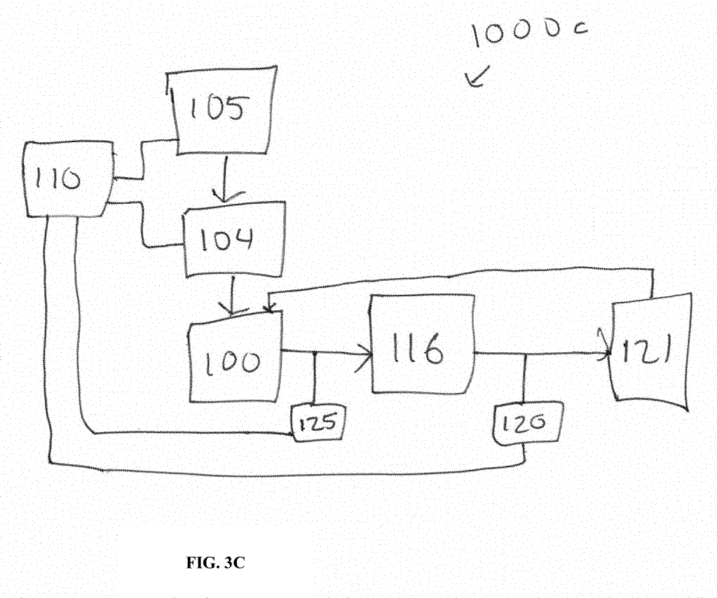

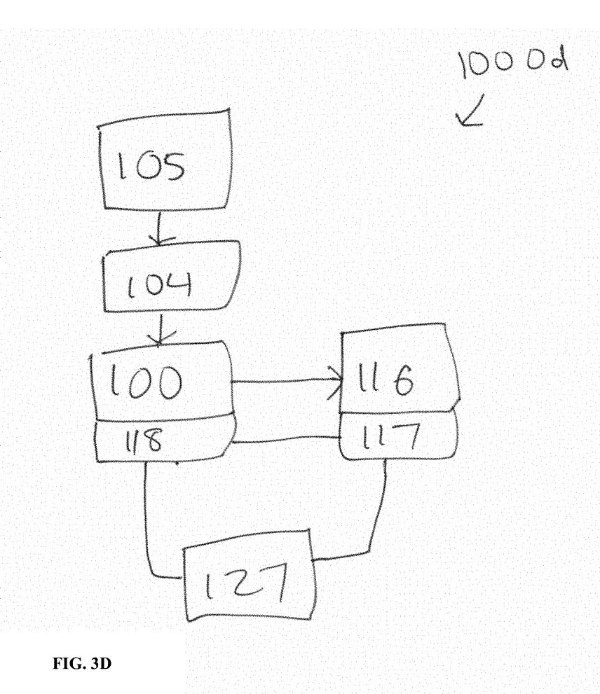

FIGS. 3A, 3B, 3C and 3D are schematics of system 1000 in accordance with alternative embodiments. System 1000a in FIG. 3A illustrates at least a portion of the forced air induction system, and includes air compressor 105 operatively coupled to carburetor 104, and carburetor 104 operatively coupled to engine block 100.

System 1000b in FIG. 3B includes all elements of system 1000a (FIG. 3A), and further illustrates the feedback loop control and catalytic conversion of the system. System 1000b includes catalytic converter 116 operatively coupled to engine block 100, oxygen sensor 125 operatively coupled to exhaust line between engine block 100 and catalytic converter 116, and feed back control subsystem 110 operatively coupled to both oxygen sensor 125 and air compressor 105.

System 1000c in FIG. 3C includes all elements of system 1000b (FIG. 3B), and further illustrates at least a portion of the exhaust gas recirculation system. System 1000c includes EGR valve 121 operatively coupled to catalytic converter 116 and engine block 100, oxygen sensor 120 operatively coupled to exhaust line between catalytic converter 116 and EGR valve 121, and operative coupling between feed back control subsystem 110 and carburetor 104.

System 1000d in FIG. 3D includes all elements of system 1000a (FIG. 3A), and additionally illustrates at least a portion of the waste heat energy system. System 1000d includes catalytic converter 116 operatively coupled to engine block 100, heat exchanger 117 operatively coupled to catalytic converter 116, heat exchanger 118 operatively coupled to engine block 100, and heat exchanger 127 operatively coupled to heat exchangers 117 and 127.

### Atomizer

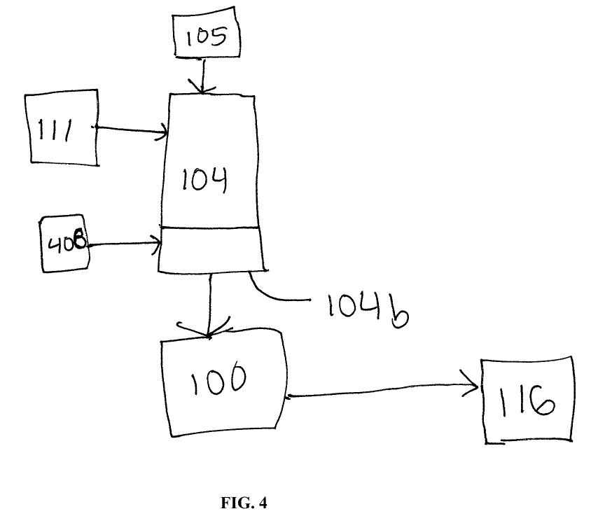

With reference to FIG. 4, some embodiments of system 1000 include piezoelectric atomizer 408. Piezoelectric atomizer 408 is positioned to deliver atomized water to throttle 104b of carburetor 104, as opposed to delivery of atomized water directly into the combustion chamber of engine block. Delivery of atomized water from piezoelectric atomizer 408 reduces the content of NOₓ and/or CO contained within exhaust from engine block 100.

### Method of Controlling an Energy Conversion or Transfer System

Certain embodiments of the present disclosure relate to a method of controlling an energy conversion or transfer system. The method may be implemented using any of the systems (system 1000) described herein, including those shown and described with respect to FIGS. 1A, 1B, 2, 3A, 3B, 3C, and 3D.

The method may include providing an internal combustion engine having a fuel-air delivery system that includes an air intake and a carburetor. The method may include equipping the air intake with an air compressor.

The method may include operating the internal combustion engine, including delivering an air/fuel mixture from the carburetor to the internal combustion engine.

The method may include adjusting the air/fuel ratio by controlling air intake into the internal combustion engine and fuel supply into the carburetor. The air intake may be controlled by regulating the air compressor speed. The fuel supply may be controlled by regulating operating parameters of the fuel pump. Air/fuel ratio may be controlled to achieve a target stoichiometric combustion efficiency. The air/fuel ratio may be adjusted in response to oxygen content of exhaust from the internal combustion engine, oxygen content of exhaust from a catalytic converter downstream of the internal combustion engine, or combinations thereof. In some embodiments, the air/fuel ratio is adjusted to vary the oxygen supply to the catalytic converter sufficient to provide a catalytic effect in the catalytic convertor.

The method may include recovering waste heat produced in the internal combustion engine and the catalytic converter. The recovered waste heat may be transferred to at least one dump or export heat exchanger and/or to an external heat sink. The external heat sink may be a heating ventilation system, a boiler, a heater for water distillation, or combinations thereof.

The method may include recirculating at least a portion of exhaust gas from the catalytic converter to the internal combustion engine. The recirculation of the exhaust gas may be controlled based on oxygen content of the exhaust gas. In some embodiments, the recirculation of the exhaust gas is controlled by opening or closing an EGR valve in response to the oxygen content of the exhaust gas. The EGR valve may be opened or closed based on a trip point of oxygen content in the exhaust gas, or the EGR valve may be throttled over a range of oxygen content values in the exhaust.

The method may include transferring mechanical energy from the internal combustion engine to an electric generator, a compressor, or combinations thereof operatively coupled to the internal combustion engine.

The following Examples are for illustrative purposes only, and are not intended to limit the scope of the present disclosure.

### EXAMPLE 1

### Rich Air/Fuel Ratio

If system 1000 operates with insufficient oxygen for stoichiometric or approximately stoichiometric combustion, oxygen sensors (e.g., oxygen sensor 125) of system 1000 will detect the content levels of oxygen in exhaust that are below a predetermined lower value for the content level of oxygen. In some embodiments, rather than, or in addition to, detecting content levels of oxygen in exhaust, system 1000 may include sensors configured to detect chemical species indicative of incomplete combustion, such as CO. In response to a signal from such chemical sensors (e.g., oxygen sensor 125) that indicates incomplete combustion, feed back control subsystem 110 may send a control signal to air compressor 105, fuel supply 111, or combinations thereof to adjust the air/fuel ratio to achieve stoichiometric or approximately stoichiometric combustion. For example, such control signals may operatively control a valve of fuel supply 111 closing or throttling the valve through which the fuel flows from fuel supply 111 into carburetor 104 to reduce the amount of fuel entering carburetor 104, thereby increasing the air/fuel ratio, such that stoichiometric or approximately stoichiometric combustion may be achieved. Also, such control signals may operatively control air compressor 105 by increasing air compressor speed to increase the flow rate of intake air into carburetor 104 relative to that of fuel from fuel supply 111, thereby increasing the air/fuel ratio, such that stoichiometric or approximately stoichiometric combustion may be achieved.

Generally, control of the speed (RPM) of the compressor as referred to above means increasing the output pressure of the compressor, and thereby, engine volumetric efficiency. Using oxygen sensors (for example) to measure and monitoring stoichiometric efficiency, readings (signals) are preferably fed to a controller and used in a feedback control loop to control fuel delivery and compressor speed, thereby adjusting fuel and air supply rates to optimize stochiometric efficiency. The compressor (and, in turn, the engine) is said to be responsive to the readings of the sensors and the settings on the feedback control loop.

### EXAMPLE 2

### Lean Air/Fuel Ratio

If system 1000 operates with excess oxygen for stoichiometric or approximately stoichiometric combustion, oxygen sensors (e.g., oxygen sensor 125) of system 1000 will detect the content levels of oxygen in exhaust that are above a predetermined upper value for the content level of oxygen. In response to a signal from such chemical sensors (e.g., oxygen sensor 125), feed back control subsystem 110 may send a control signal to air compressor 105, fuel supply 111, or combinations thereof to adjust the air/fuel ratio to achieve stoichiometric or approximately stoichiometric combustion. For example, such control signals may operatively control a valve of fuel supply 111 open or throttling the valve through which the fuel flows from fuel supply 111 into carburetor 104 to increase the amount of fuel entering carburetor 104, thereby decreasing the air/fuel ratio, such that stoichiometric or approximately stoichiometric combustion may be achieved. Also, such control signals may operatively control air compressor 105 by decreasing air compressor speed to decrease the flow rate of intake air into carburetor 104 relative to that of fuel from fuel supply 111, thereby decreasing the air/fuel ratio, such that stoichiometric or approximately stoichiometric combustion may be achieved.

### EXAMPLE 3

### Catalytic Converter Operation

If system 1000 operates with excess oxygen for catalyst oxidation of carbon monoxide (CO) and hydrocarbons (HC), as well as reducing nitrous oxides (NOx) within catalytic converter 116, oxygen sensors (e.g., oxygen sensor 120) of system 1000 will detect the content levels of oxygen in exhaust downstream of catalytic converter 116 that are above a predetermined upper value for the content level of oxygen. In response to a signal from such chemical sensors (e.g., oxygen sensor 125), feed back control subsystem 110 may send a control signal to air compressor 105, fuel supply 111, or combinations thereof in the manners described herein to adjust the air/fuel ratio to result in a reduced amount of oxygen entering catalytic converter 116.

If system 1000 operates with insufficient oxygen for catalyst oxidation of carbon monoxide (CO) and hydrocarbons (HC), as well as reducing nitrous oxides (NOx) within catalytic converter 116, oxygen sensors (e.g., oxygen sensor 120) of system 1000 will detect the content levels of oxygen in exhaust downstream of catalytic converter 116 that are below a predetermined lower value for the content level of oxygen. In response to a signal from such chemical sensors (e.g., oxygen sensor 125), feed back control subsystem 110 may send a control signal to air compressor 105, fuel supply 111, or combinations thereof in the manners described herein to adjust the air/fuel ratio to result in a increased amount of oxygen entering catalytic converter 116.

It should be noted and understood that many of the specific features or combination of features illustrated in or introduced FIGS. 1A, 1B, 2, 3A, 3B, 3C, and 3D (or described in the claims submitted below), and\or discussed in accompanying descriptions, may be combined with or incorporated with other feature(s) or embodiment(s) described or illustrated in any other figure provided herein. For example, features or components described in respect or illustrated in FIGS. 1A or 1B may be incorporated with an energy handling system that is operated or controlled according to the present disclosure.

Moreover, the following claims serve also to describe and illustrate some (but not all) aspects of the present disclosure. The claims serve therefore as an integral part of the present disclosure.

The foregoing description has been presented for purposes of illustration and description of preferred embodiments. This description is not intended to limit associated concepts to the various systems, apparatus, structures, processes, and methods specifically described herein. For example, aspects of the control processes or the feedback control processes described herein in respect to the systems or apparatus of FIGS. 1A, 1B, 2, 3A, 3B, 3C, and 3D may be employed or prove suitable for use with other energy systems, and energy handling or conversion systems and apparatus. The embodiments described and illustrated herein are further intended to explain the best and preferred modes for practicing the system and methods, and to enable others skilled in the art to utilize same and other embodiments and with various modifications required by the particular applications or uses of the present disclosure.

1. An energy conversion or transfer system comprising:
an internal combustion engine; and
a fuel-air delivery system in fluid communication with the internal combustion engine, the fuel-air delivery system including an air intake and a carburetor for delivering a fuel-air mixture to the engine, the air intake being equipped with an air compressor delivering compressed air to the carburetor; and
wherein the carburetor is disposed between said compressor and said engine, and receives compressed intake air discharged from the air compressor and fuel from a fuel supply, and delivers an air-fuel mixture to the engine.

2. The system of claim 1, further comprising a heat exchanger or intercooler disposed downstream of the compressor and in fluid communication with compressed intake air discharging from the compressor prior to delivery to the carburetor.

3. The system of claim 1, wherein the air compressor is an electric drive air compressor driven independently of the engine, the system further comprising:
an exhaust subsystem disposed downstream of said engine to convey exhaust gases therefrom; and
a feedback control subsystem configured in communication with the air compressor and at least one post-combustion sensor disposed in communication with said exhaust system and exhaust gases discharging from said engine, such that said delivery of compressed air by said compressor is variably responsive to communications by said post-combustion sensor to said feedback control system.

4. The system of claim 1, further comprising a catalytic converter disposed downstream of the internal combustion engine, the catalytic converter disposed to receive exhaust from the internal combustion engine.

5. The system of claim 4, further comprising a feed back control subsystem in communication with the air compressor, the fuel supply, or combinations thereof, the feed back control subsystem configured to adjust the air/fuel ratio by controlling air intake into the carburetor, fuel supply into the carburetor, or combination thereof.

6. The system of claim 5, wherein the feed back control subsystem includes at least oxygen sensor positioned downstream of the internal combustion engine.

7. The system of claim 6, wherein the at least one oxygen sensor comprises a post-combustion oxygen sensor downstream of the internal combustion engine and upstream of the catalytic converter, a post-catalytic oxygen sensor downstream of both the internal combustion engine and the catalytic converter, or combinations thereof.

8. (canceled)

9. The system of claim 5, wherein the feed back control subsystem controls air intake into the internal combustion engine by regulating air compressor speed of the air compressor.

10. (canceled)

11. The system of claim 4, further comprising a waste heat energy system disposed to collect heat from the internal combustion engine and from the catalytic converter, the waste heat energy system including at least one heat exchanger positioned in heat transfer relation to exhaust emitted downstream of the internal combustion engine and at least one heat exchanger positioned in heat transfer relation to the catalytic converter.

12. The system of claim 11, wherein the waste heat energy system further comprises at least one heat exchanger positioned in heat transfer relation to an exhaust from the catalytic converter.

13. The system of claim 11, wherein the waste heat energy system further comprises at least one dump or export heat exchangers in heat transfer relation with each heat exchanger of the waste heat energy system.

14. The system of claim 13, further comprising an external heat sink in heat transfer relation with the dump or export heat exchanger.

15. (canceled)

16. The system of claim 4, further comprising an exhaust gas recirculating system in fluid communication with the catalytic converter, and disposed to recirculate at least a portion of exhaust from the catalytic converter to the internal combustion engine.

17. The system of claim 16, wherein the exhaust gas recirculating system comprises:
an oxygen sensor disposed to detect an oxygen content of the exhaust downstream of the catalytic converter;
a controller in communication with the oxygen sensor; and
an exhaust gas recovery (EGR) valve in communication with the controller;
wherein the EGR valve is disposed to recycle exhaust gas to the internal combustion engine based on excess oxygen content in the exhaust as measured by the oxygen sensor.

18. The system of claim 17, wherein the controller is a solenoid circuit configured to open or close the EGR valve based on a trip point of oxygen content in the exhaust gas, or wherein the controller is a proportional integral derivative (PID) controller configured to throttle the EGR valve over a range of oxygen content values in the exhaust.

19. The system of claim 4, wherein the catalytic converter includes an integral heat exchanger for recirculating post catalytic exhaust gases.

20. The system of claim 1, further comprising an electric generator, a compressor, or combinations thereof operatively coupled to the internal combustion engine.

21. The system of claim 1, wherein control of the air compressor is independent of control and operation of the internal combustion engine.

22. The system of claim 1, further comprising a piezoelectric atomizer disposed to deliver atomized water to a throttle of the carburetor.

23. A method of controlling an energy conversion or transfer system comprising:
providing an internal combustion engine having a fuel-air delivery system that includes an air intake and a carburetor, the air intake being equipped with an air compressor;
operating the internal combustion engine, including delivering an air/fuel mixture from the carburetor to the internal combustion engine; and
adjusting the air/fuel ratio by controlling air intake into the internal combustion engine and fuel supply into the carburetor, wherein the air intake is controlled by regulating the air compressor speed.

24-39. (canceled)
